(19) United States
(12) Patent Application Publication
(10) Pub. No.: US 2015/0310964 A1
(43) Pub. Date: Oct. 29, 2015

(54) UNITARY FURCATING HYBRID FIBER OPTIC AND POWER CABLE

(71) Applicant: 3M INNOVATIVE PROPERTIES COMPANY, St. Paul, MN (US)

(72) Inventors: Donald K. LARSON, Cedar Park, TX (US); Stephen C. KING, Lakeway, TX (US); Curtis L. SHOEMAKER, Round Rock, TX (US); William J. CLATANOFF, Austin, TX (US); Stephen Paul LeBLANC, Austin, TX (US); Robert M. ANDERTON, Cedar Park, TX (US); LayLonie L. Le VAN-ETTER, The Woodlands, TX (US)

(21) Appl. No.: 14/461,812

(22) Filed: Aug. 18, 2014

Related U.S. Application Data
(60) Provisional application No. 61/871,493, filed on Aug. 29, 2013.

(51) Int. Cl. H01B 9/00; H01B 7/08; H04B 10/2575; G02B 6/44

(52) U.S. Cl. CPC H01B 9/005; G02B 6/4416; G02B 6/441; G02B 6/4432; G02B 6/4495; H01B 7/0823; H04B 10/25752

(57) ABSTRACT

Cable assemblies, premises and wireless cabling systems utilizing such assemblies, and cable units found within such cable assemblies are described. More particularly, cable assemblies that can be furcated and include both optical fibers and electrical conductors are described. Such assemblies can include a plurality of cable units disposed within a primary jacket that surrounds the cable units, with at least some units including optical fibers and at least some units including electrical conductors that may have a conductivity of greater than 1 e⁷ S/m.

### FIELD

The present description relates to cable assemblies, premises and wireless cabling systems utilizing such assemblies, and cable units found within such cable assemblies. More particularly, the present description relates to cable assemblies that can be furcated and include both optical fibers and electrical conductors.

### BACKGROUND

The continuing expansion of wireless communication and its accompanying wireless technology will require many more “cell sites” than currently deployed. This expansion has been estimated from a doubling to a ten-fold increase in the current number of cell sites, particularly in the deployment of 4G/LTE. This dramatic increase in the number of cell sites is due, in large part, to the high bandwidth demand for wireless applications and the bandwidth to the cell site must be shared to the available UE (user equipment) within range of the site.

One existing means of providing fiber to remote radio units on various structures such as towers, buildings or other structures involves placing a sealed junction box at the top of the structure with a multi-fiber cable and power cables spanning the distance between the junction box and a source cabinet. Inside the sealed junction box, the cable is terminated into a panel. Multiple jumper fiber optic cables and power cables are then run from the panel to the remote radio units.

### SUMMARY

In one aspect, the present description relates to a cable assembly. The cable assembly includes a plurality of cable units disposed within a primary jacket that surrounds the cable units, and each cable unit comprising a secondary jacket surrounding its respective cable unit and positioned within the primary jacket. The primary jacket has a plurality of indentations disposed between adjacent cable units that allow an installer to furcate the cable assembly into smaller cable groupings. The primary jacket is capable of remaining around each cable grouping when the cable assembly is furcated, wherein at least one first cable unit of the plurality of cable units comprises optical fibers and at least one second cable unit of the plurality of cable units comprises an electrical conductor having a conductivity of greater than 1×10⁷ S/m.

In a different aspect, the present description relates to a premises cabling system. The premises cabling system includes a cable assembly having a plurality of cable units disposed within a unitary cable assembly jacket that surrounds the cable units. The cable assembly jacket has a plurality of indentations disposed between adjacent cable units and at least one cable unit of the plurality of cable units is configured to carry a communications signal. Additionally, at least one cable unit of the plurality of cable units is configured to transmit power. The system further includes a furcation point positioned near an access location of a premises structure. At least one subassembly is separated from the cable assembly and is routed to an access node within the premises structure.

In yet another aspect, the present description relates to a cabling system for a wireless communication installation. The cabling system includes a head end, at least one remote radio unit disposed on a support structure, and a cable assembly connecting the head end to the at least one remote radio unit. The cable assembly has a plurality of cable units disposed within a unitary cable assembly jacket that surrounds the cable units. The cable assembly jacket has a plurality of indentations disposed between adjacent cable units, and at least one cable unit of the plurality of cable units is configured to carry a communications signal between the head end and the at least one remote radio unit. Further, at least one cable unit of the plurality of cable units is configured to transmit power for the at least one remote radio unit.

In another aspect, the present description relates to a cable assembly. The cable assembly includes a plurality of cable units disposed within a unitary cable assembly jacket that surrounds the cable units. The cable assembly jacket has a plurality of indentations disposed between adjacent cable units, and at least one cable unit of the plurality of cable units is configured to carry a communications signal. Further, at least one cable unit of the plurality of cable units is configured to transmit electrical power. A furcation point is positioned at a branch location on the cable assembly.

In a different aspect, the present description relates to a cable unit. The cable unit includes at least one optical fiber, at least two electrical conductors, and a jacket surrounding the optical fibers and electrical conductors. The electrical conductors have a conductivity of greater than 1×10⁷ S/m and are disposed on opposite sides of the optical fiber. Additionally, the electrical conductors have a diameter and a defined space between the electrical conductors, the ratio of diameter of electrical conductor to defined space between electrical conductors being between about 0.41 and 0.58. Further, the electrical conductors have an impedance of between about 95 ohms and 105 ohms.

### BRIEF DESCRIPTION OF THE DRAWINGS

Throughout the specification, reference is made to the appended drawings, where like reference numerals designate like elements, and wherein:

FIGS. 1A-1B illustrates a prior art cable assembly.

FIGS. 2A-2C illustrate a cable assembly according to the present description.

FIGS. 3A-3B illustrate a cable assembly according to the present description.

FIGS. 4A-4B illustrate a cable assembly according to the present description.

FIGS. 5A-5B illustrate a cable assembly according to the present description.

FIG. 6 illustrates a premises cabling system according to the present description.

FIG. 7 illustrates a cable assembly positioned within a microtrench according to the present description.

FIG. 8 illustrates a cabling system for wireless communication installation according to the present description.

FIG. 9 illustrates a support structure for a cabling system according to the present description.

FIG. 10 illustrates a support structure for a cabling system according to the present description.

FIG. 11 illustrates a support structure for a cabling system according to the present description.

FIGS. 12A-12B illustrate a cable assembly according to the present description.

FIGS. 13A-13B illustrate a cable assembly according to the present description.

FIG. 14 illustrates a cable assembly according to the present description.

FIGS. 15A-15B illustrate a cable assembly according to the present description.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “forward,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

As noted in the background section, one existing means of providing fiber to remote ratio units on various structures such as towers, buildings or other structures involves placing a sealed junction box at the top of the structure with a multi-fiber cable and power cables spanning the distance between the junction box and a source cabinet. Inside the sealed junction box, the cable is terminated into a panel. Multiple jumper fiber optic cables and power cables are then run from the panel to the remote radio units. One drawback of the junction box, beyond its large space consumption on a structure, and the potential difficulty in installing it, is sealing issues that may be associated with the box, potentially exposing the panel to moisture and the like. It would be highly beneficial if one were able to eliminate the need for such a junction box and associated issues, and be capable of routing power and fiber cable directly to remote units from a source cabinet or head end. In other words, it would be beneficial to solve the problem of getting optical fiber to a remote device while supplying power and/or control signals, negating the need for a separate power or signal source. The present description provides such a system solution, as well as a cable assembly that enables such a solution.

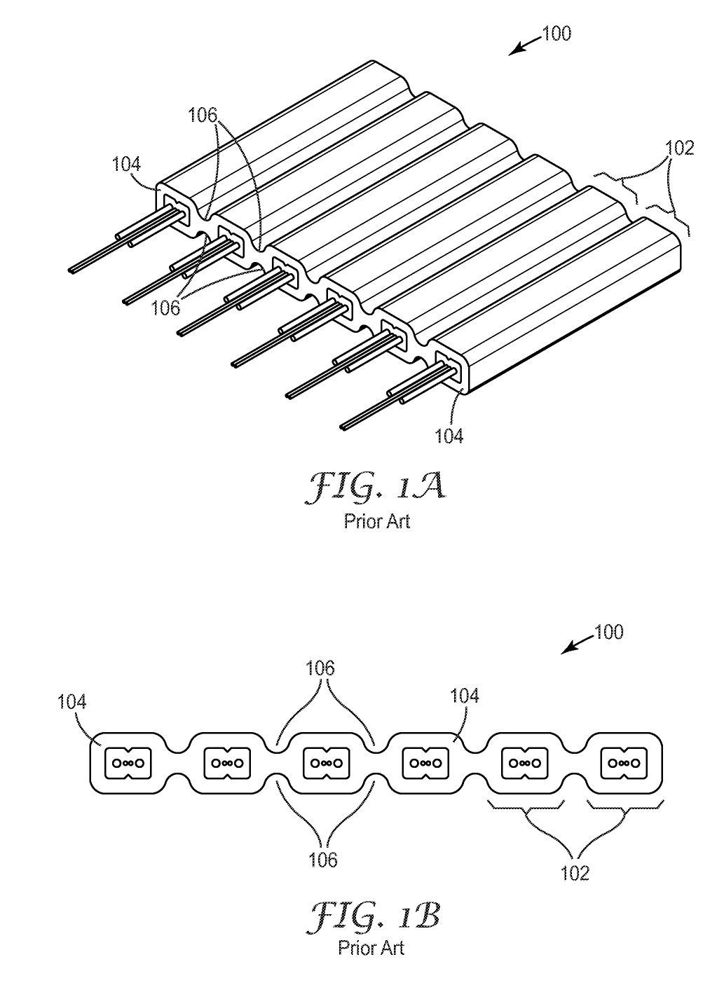

FIGS. 1A and 1B illustrate a solution described generally in commonly owned and assigned PCT Publication WO 2013/048890. Provided is a cable assembly 100 that includes a plurality of optical fiber cable units 102 that are disposed within a unitary cable assembly jacket 104 that surround the optical fiber cable units. The cable assembly jacket 104 has a plurality of indentations 106 that are disposed between adjacent optical fiber cable units. These indentations 106 allow an installer to furcate the cable assembly 100 into smaller cable groupings at a convenient remote location, such as at a tower location or roof mounted support location. Despite the major benefits of allowing a user to furcate the cable units from the unitary assembly at multiple remote locations, the described embodiment does not solve the additional problem of further supplying power and/or transmission media or cable without the need for a separate power or signal source.

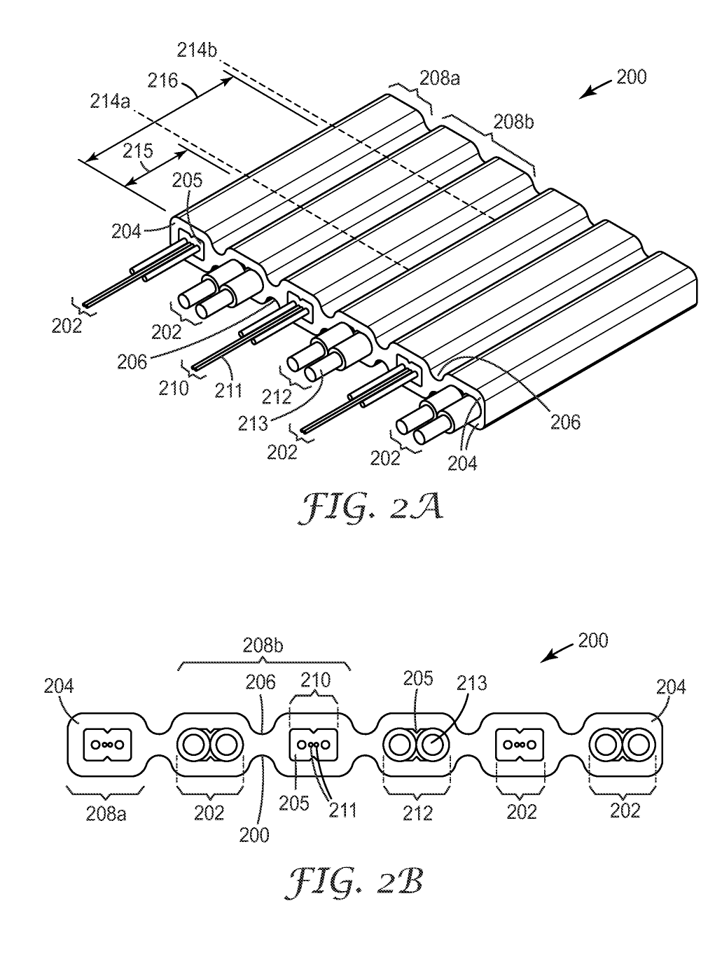

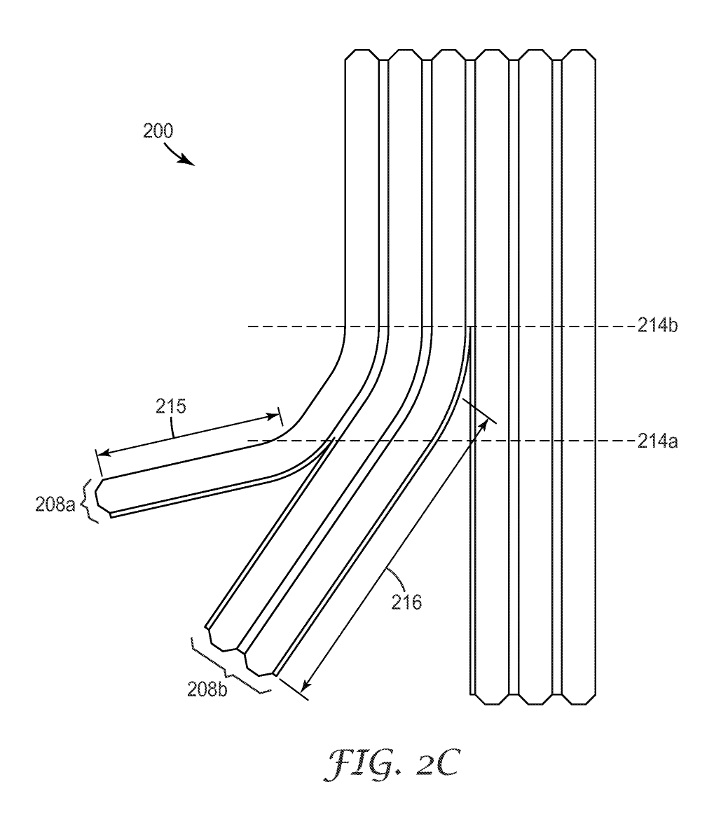

FIGS. 2A and 2B illustrate a first embodiment of the cable assembly solution provided in the present description. Cable assembly 200 includes a plurality of cable units 202 disposed within a primary jacket 204 that surround the cable units 202. In some embodiments, the primary jacket may be formed from a polymer material, such as polyethylene. In other embodiments, the primary jacket may be formed from a UV stabilized polyethylene material. Other materials may also be suitable materials for the primary jacket, such as polypropylene, polyvinyl chloride (PVC), TPE, neoprene, polyurethane or fluoropolymers such as FEP and PFA. The primary jacket material thickness at the indentations 206 can be from about 0.5 mm to about 1.5 mm. This indentation thickness will generally be on the order of the thickness of the primary jacket that surrounds the secondary jacket around each cable unit. Accordingly, the cable assembly, while having a generally planar profile, can have some flexibility. For example, the cable assembly 200 can be bent upwards or downwards at one or more indentation locations, thereby resulting in a curved shape in cross-section allowing the assembly to be conformed to a number of non-planar surfaces.

Each cable unit 202 comprises a secondary jacket 205 surrounding its respective cable units (most easily notable in FIG. 2A) and positioned within the primary jacket. The secondary jacket may in some embodiments be made of a foil, such as copper foil or aluminum foil. Other appropriate materials for shielding the power or signal transmission components within the unit may also be utilized. The primary jacket 204 has a plurality of indentations 206 that are disposed between adjacent cable units. These indentations allow an installer to furcate the cable assembly 200 into smaller cable groupings, where the primary jacket is capable of remaining around each smaller cable grouping when the cable assembly is furcated. For example, a user can furcate the assembly into a cable grouping 208a that includes only one cable unit. Alternatively, a user can furcate the cable assembly into a cable grouping 208b that includes multiple cable units, potentially including a unit or units that carry optical fibers and a unit or units that carry power. At least one first cable unit 210 of the plurality of cable units in the cable assembly includes optical fibers 211. The optical fibers can be conventional optical fibers having a conventional fiber coating diameter of 250 μm or 900 μm.

The first cable unit may be a conventional dual fiber, FRP-type cable unit, such as those available from Aksh Technologies, Furakawa, and other commercial suppliers. FRP-type units may be understood as a drop cable including at least one optical fiber disposed centrally within and extending longitudinally with the drop cable body and further having two semi-rigid strength members disposed on either side of the at least one optical fiber. A protective jacket is formed around the at least one optical fiber and the two strength members which defines the cross-sectional shape of the drop cable body. In an exemplary aspect, the drop cable body can have a roughly figure eight shape with the at least one optical fiber disposed near the waist of the drop cable body and the strength members disposed in lobe portions formed on either side of the waist of the drop cable body. In an exemplary aspect, the semi-rigid strength members can be fiber re-enforced polymer rods or steel wires. Alternatively, the cable unit may be a jacketed duplex cable or a jacked fiber ribbon cable.

At least one second cable unit 212 of the plurality of cable units in the cable assembly includes an electrical conductor 213 having a conductivity of greater than 1×10⁷ S/m. In at least one embodiment, the electrical conductor 213 may be made up of copper, however other appropriate materials may also be utilized. Electrical conductor may also be made of aluminum wire. Electrical conductor may be in the form of single conductor, stranded conductor or coaxial conductors.

Looking specifically to FIGS. 2A and 2C, another aspect of the present description is provided. In cable assembly 200, the smaller cable groupings 208a or 208b may be furcated from the cable assembly for a first length of the smaller cable grouping at at least one point along the length of the cable assembly 200. For example, smaller cable grouping 208a may be separated from the unitary cable assembly at furcation point 214a along the length of the cable assembly, such that a first length 215 branches from the cable assembly at the furcation point. Additionally, smaller cable groupings may be furcated from the cable assembly at different points along the length of the cable assembly. For example, smaller cable grouping 208b may be furcated from the unitary cable assembly at point 214b, such that length 216 of cable grouping 208a and 208b is separated from the unitary cable assembly. Of course, smaller cable grouping of one or multiple cable units may be split from the cable assembly at more than two points along the length of the cable assembly as well and should be understood to fall within the scope of the present disclosure. Additionally, smaller cable groupings can be furcated from the same side of the cable assembly or opposite sides of the cable assembly.

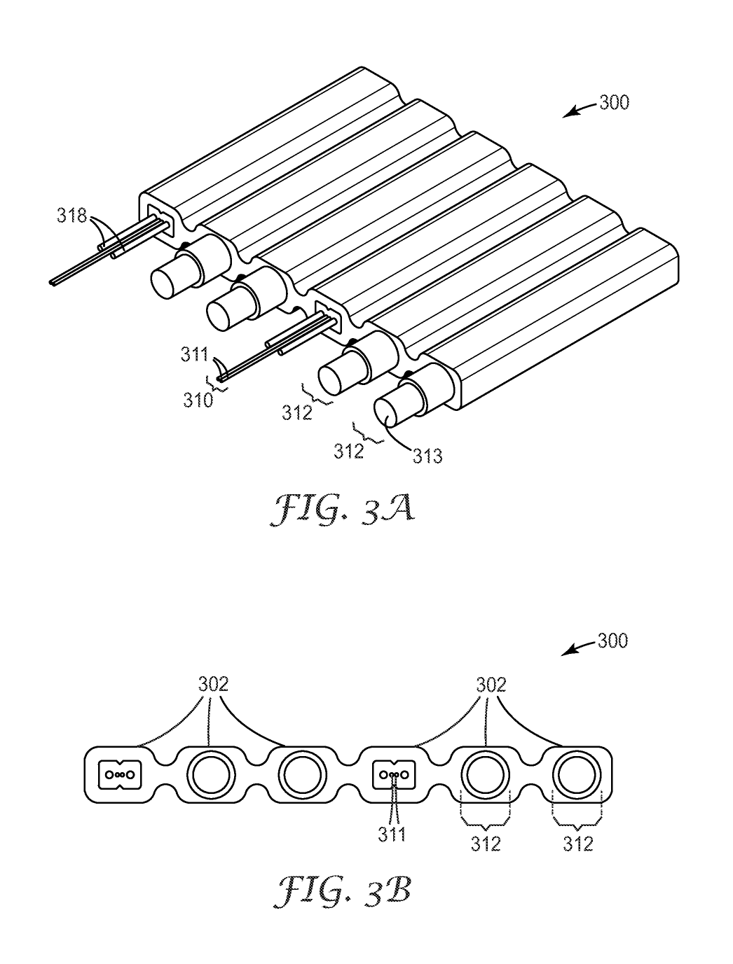

FIGS. 3A-3B illustrate another potential embodiment of a cable assembly according the present description, and provide further understanding of the elements of not only this embodiment, but elements of other embodiments according to the present description. Cable assembly 300 includes first cable units 310 having optical fibers 311 and second cable units 312 including electrical conductors 313, potentially electrical conductors having a conductivity of greater than 1 e⁷ S/m. In the current embodiment, the cable assembly can include two adjacent cable units that each include an electrical conductor. On each side of the directly adjacent second cable units 312 are first cable units 310 that include optical fibers. As illustrated in both FIGS. 2A-2B and FIGS. 3A-3B, the first cable unit 210, 310 may include duplex optical fibers 211, 311. As provided in FIGS. 2A-2C, the first cable unit may be a conventional dual fiber, FRP-type cable unit. Cable unit may include strength members 318 that may, for example, be positioned parallel to the optical fibers 311, and may be positioned on opposite sides of an optical fiber (or fibers, in the case of a duplex optical fibers, such as illustrated). In at least some embodiments, strength members 318 may be polymer rods. Strength members 318 may also be made up of other conventional strength member materials such as fiber reinforced plastic, metal rods or wires, and/or aramid fibers. The strength members reinforce the fiber and protect it from crushing as well as offering a tension member for the cable unit. In one embodiment, the strength members may actually be made up of electrically conducting material, such as copper. In such an embodiment, the cable unit will include both communication capability via optical fiber and power transport via the electrical conductor.

Both FIGS. 2A-2B and FIGS. 3A-3B illustrate an embodiment in which six cable units are present in the cable assembly. In some embodiments, only two or more cable units exist in the cable assembly. However, at least six cable units may be present. In alternative embodiments, the cable assembly may include at least eight cable units. Additionally, as illustrated, the cable assembly 200 or 300 may include a plurality of first cable units 210/310 which include optical fiber. The cable assembly 200 or 300 may also include a plurality of second cable units 212/312 that include electrical conductor, such as copper a wire.

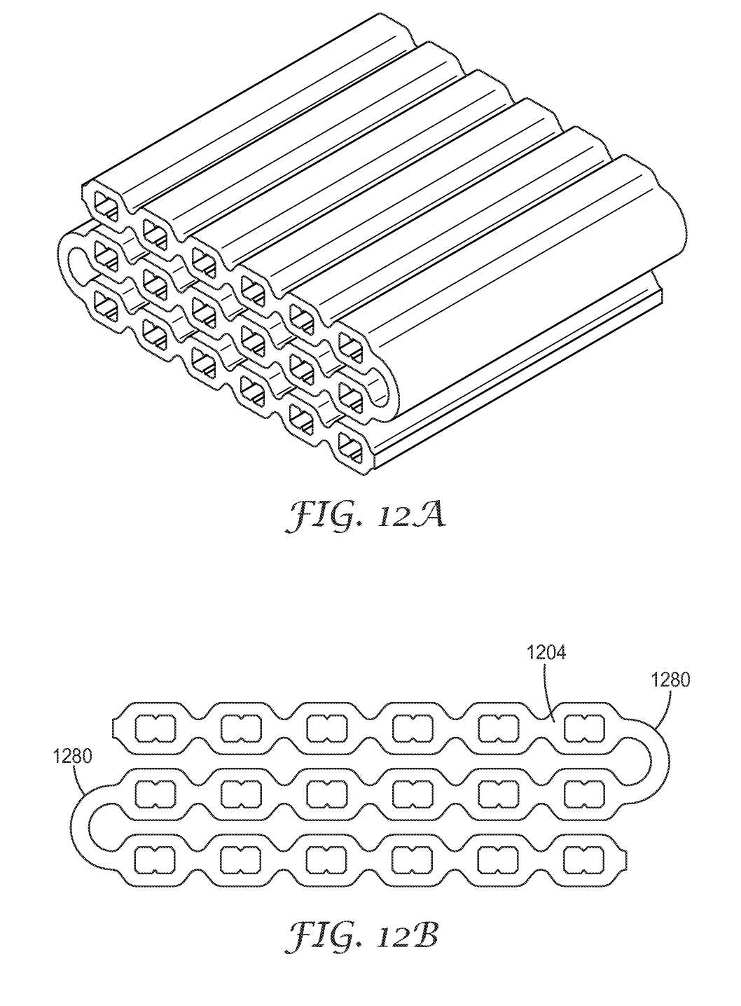

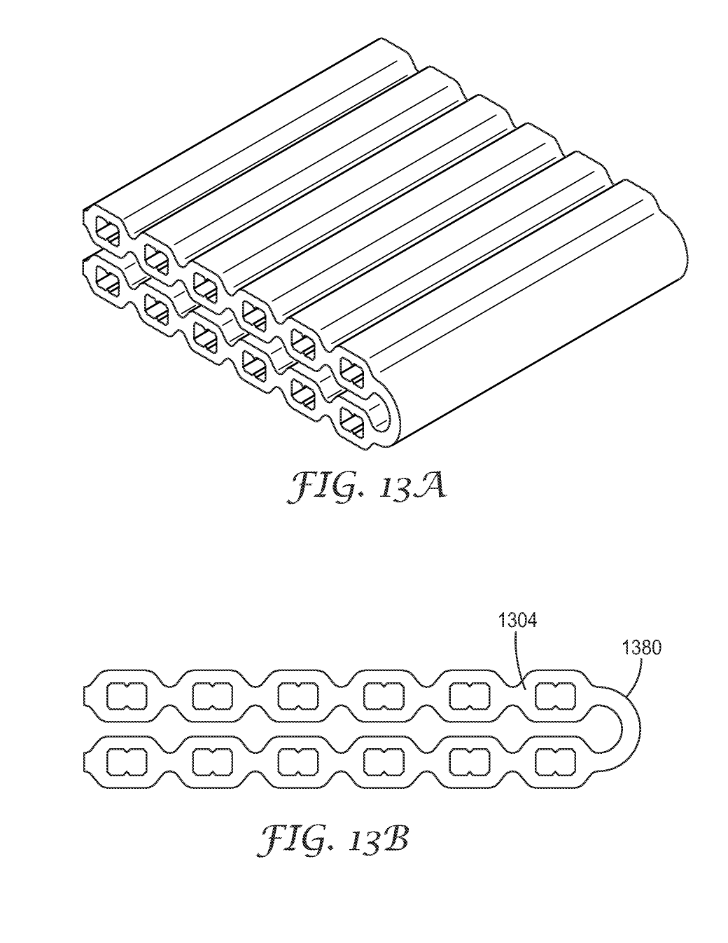

A greater plurality of cable units (e.g. 12 or more) may be provided in one cable assembly without making the assembly prohibitively wide, or forcing it to protrude too far from the surface on which it is mounted, depending on how the assembly is constructed. Looking to FIGS. 12A and 12B and FIGS. 13A and 13B for example, constructing the assembly with lengthened portions 1280 and 1380 of the jackets 1204 or 1304 at given intervals of cable units may allow one to essentially radially fold the cable units at the lengthened portions 1280 and 1380. Lengthened portions 1280 and 1380 are constructed to enable the cable assembly to fold 180 degrees without interference or strain to the primary jacket. This ability to fold allows for three rows of six cable units per row in FIGS. 12A and 12B and two rows of six cable units per row in FIGS. 13A and 13B, or 18 and 12 cable units per cable assembly, respectively. Any other numbers of rows and units per row may are contemplated where appropriate for a given application.

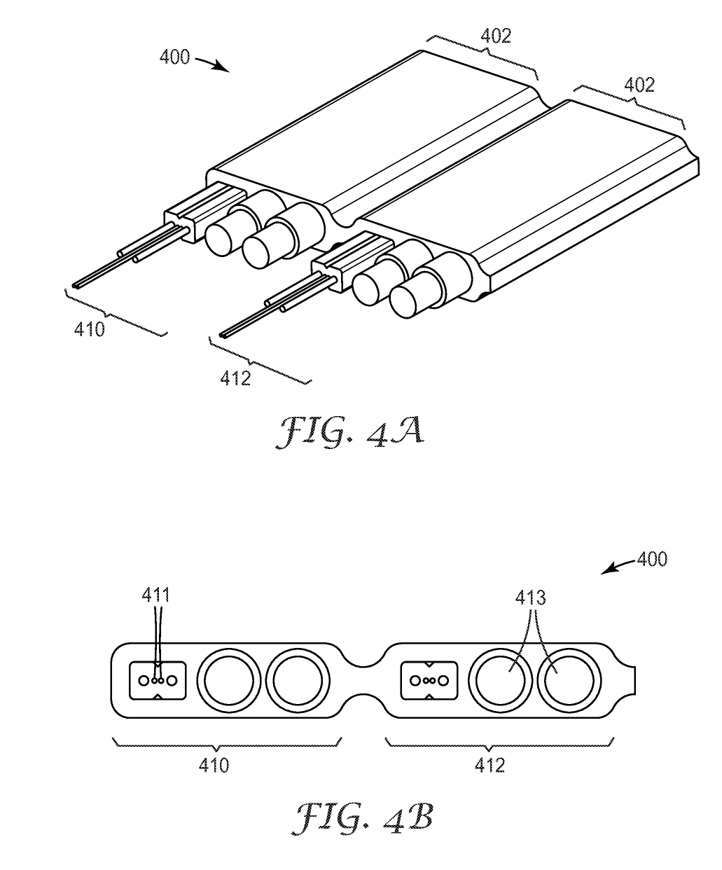

Yet another embodiment of a cable assembly according to the present description is illustrated in FIGS. 4A and 4B. These figures illustrate a cable assembly 400 with two cable units 402. In this particular embodiment, each cable unit includes both optical fibers and electrical conductors within one unit. In this exemplary aspect, the first and second cable units each include a pair of optical fibers 411 and a pair of electrical conductors 413. The present embodiment includes within each cable unit two electrical conductors 413. The electrical conductors may be, e.g., copper wires, such that the second cable unit 412 (or first cable unit 410) includes a pair of copper wires.

Looking back to FIGS. 2A-2C, cable assembly 200 may be described using different terminology. In a sense, the cable assembly may be understood as a plurality of cable units 202 with a unitary cable assembly jacket 204 that surrounds the cable units. The cable assembly jacket 204 has a plurality of indentations 206 disposed between adjacent cable units. At least one cable unit 202 of the plurality of cable units illustrated is configured to carry a communications signal. Such a cable unit is illustrated by first cable unit 210 having optical fiber(s) 211. Additionally at least one cable unit 202 is configured to transit electrical power, as illustrated by second cable unit 212 with electrical conductors 213. Finally, a furcation point is positioned at a branch location on the cable assembly. Such furcation points are illustrated in FIGS. 2A and 2C at points 214a and 214b along the length of the cable assembly. Multiple furcation points may exist.

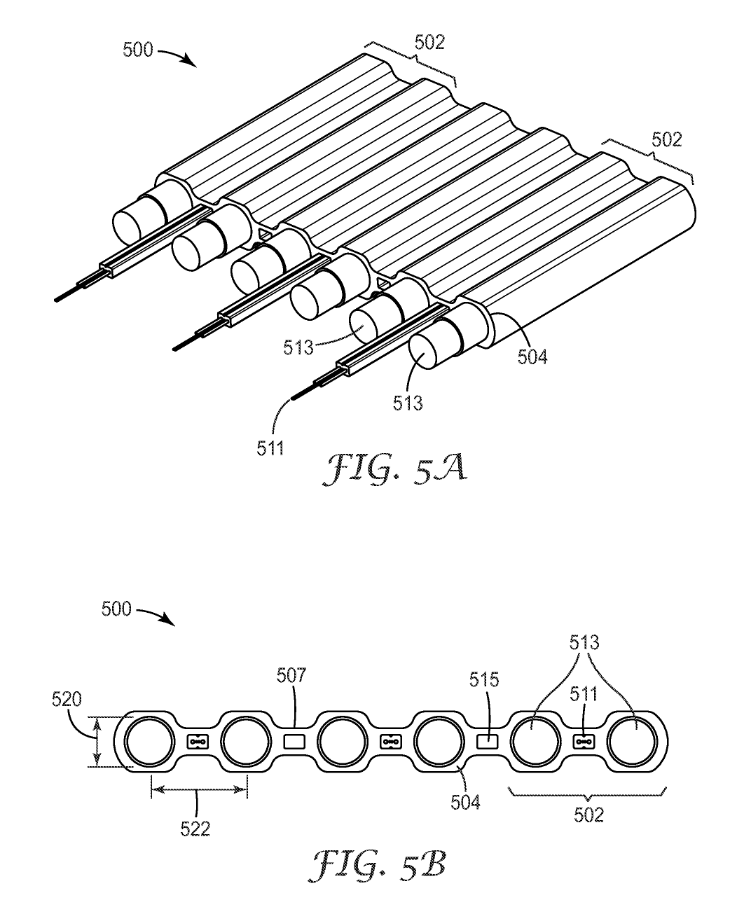

FIGS. 5A and 5B illustrates a different aspect of the present description. Cable assembly 500 includes a plurality of cable units 502. In this embodiment, each cable unit includes at least one optical fiber 511 (or duplex optical fiber 511 as illustrated), and at least two electrical conductors 513 having a conductivity of greater than 1×10⁷ S/m disposed on opposite sides of the optical fiber 511 (or fibers). The cable units further include a jacket 504 surrounding the optical fibers and electrical conductors (where the distance is defined by the distance from the center of one conductor to the center of an adjacent conductor). The electrical conductors have a diameter 520 and a defined space 522 between the electrical conductors. The ratio of the diameter of electrical conductor to the defined space between electrical conductors is between about 0.41 and 0.58. Additionally, the electrical conductors 513 have an impedance of between about 90 ohms and 110 ohms, or between about 95 ohms and about 105 ohms, or between about 97 ohms and 103 ohms. This embodiment also includes indentations within the cable unit 502 at the position where the optical fibers are located. Additionally, certain indentations may include hollowed portions 515 within the indentation 507 that allow for easier furcation of the cable jacket at the given indentation. This furcation may be accomplished potentially without a tool, e.g., by tearing along the indentation 507 by pulling the cable units 502 positioned on opposite sides of the indentation 507 in opposing directions. This construction may further be amenable where one wishes to split the optical fiber from the cable assembly. Given its position within an indentation in the jacket 504, a user may potentially pull the opposing electrical conductors 513 in each in an opposite direction, away from the optical fibers 511, splitting the jacket at the indentation and allowing the optical fibers 511 and/or FRP cable unit to be furcated from the cable assembly.

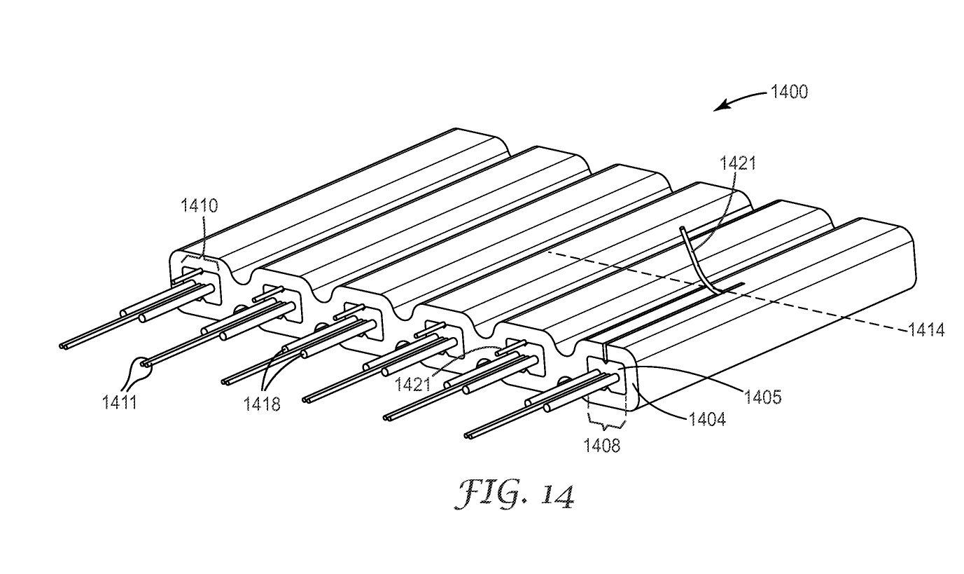

Looking back to FIGS. 3A and 3B, the FRP cable unit 310 in which the strength members on either side of optical fibers 311 are electrical conductor (such as copper) can also be understood as a cable unit with two electrical conductors disposed on opposite sides of the optical fiber or fibers 311, with a jacket surrounding the optical fibers and electrical conductors. The properties of the diameter, spacing and impedance may also hold true for such an embodiment. Alternatively, the cable assembly could be made up entirely of FRP cable units in which the cable units each include optical fibers and electrical conductors. Such a construction is illustrated in FIG. 14, in which each cable unit 1410 includes an optical fiber or duplex optical fibers 1411 with electrical conductors 1418 (such as copper wire) disposed on opposite sides of the fibers.

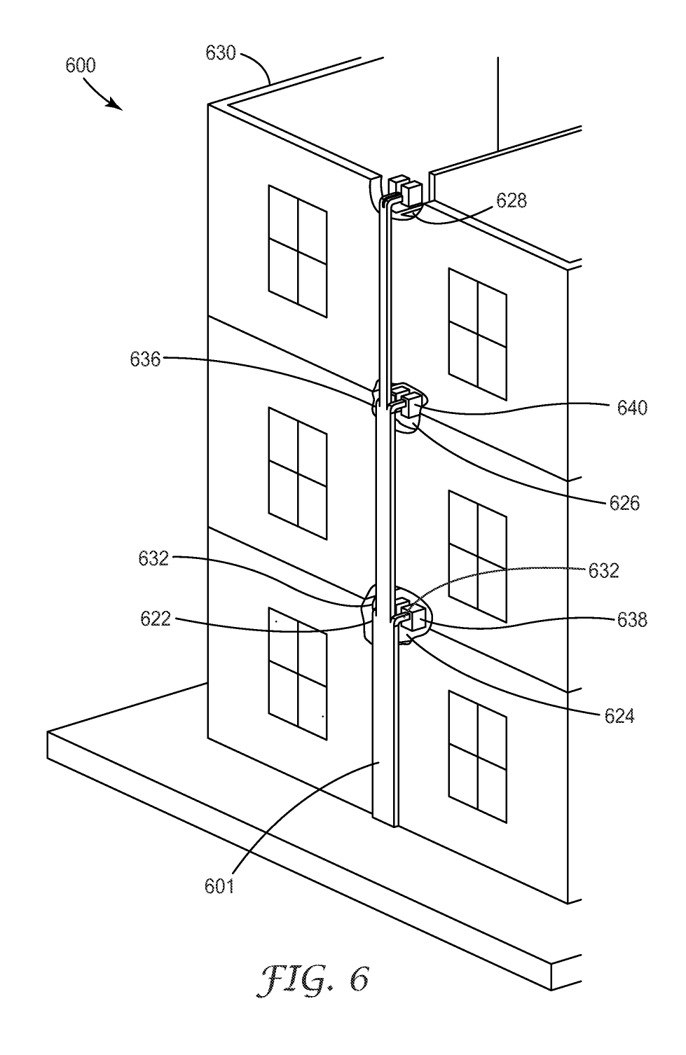

In a different aspect, the present description relates to a premises cabling system. FIG. 6 illustrates a premises cabling system 600 according to the present description. Premises cabling assembly includes a cable assembly 601 having a plurality of cable units disposed within a unitary cable assembly jacket that surround the cable units. The construction of the plurality of cable units and jacket can be any of the cable assembly embodiments described above. Additionally, as illustrated in the embodiments shown in FIGS. 2A-2C, 3A-3B, 4A-4B and 5A-5B, and provided in the description above, the cable assembly jacket (or primary jacket) may have a plurality of indentations disposed between adjacent cable units. Further at least one cable unit of the plurality of cable units is configured to carry a communications signal and at least one cable unit of the plurality of cable units is configured to transmit power. In an alternative aspect each cable unit can include conductors that carry communication signals and conductors which carry power. Cable assemblies can also be designed with two different communication signal conductors, i.e. copper (twisted pair or coax cable) and optical fiber.

Premises cabling system 600 also includes a furcation point 622. Furcation point 622 is positioned near an access location 624 of a premises structure 630. In the embodiment illustrated in FIG. 6, the access location 624 is located at the top of the first floor. Note that although the figure illustrates the access location 624 as a large opening, this is for purposes of illustrating all elements. Access location 624, will in fact be an opening just large enough to route the subassemblies through. A second access location 626 may be located at the top of the second floor of the premises structure 630, and a third access location 628 located at the top of the third floor, etc. Of course, the access locations may be at any suitable location on the premises. At the furcation point, or points, at least one subassembly 632 containing at least one cable unit (and potentially multiple subassemblies) is separated from the cable assembly 601. The cable subassembly is then routed to an access node 638 that is within the premises structure at the furcation point. In alternative embodiments, the access node may not be located proximate the furcation point, but may be, e.g., located a distance away from the furcation point, and potentially may be included on the exterior of the building. As further illustrated, the system may include a plurality of furcation points, such as both first furcation point 622 and second furcation point 636. These points are positioned at different points along the length of the cable assembly. At the second furcation point 636, another subassembly may be routed to a second access node 640.

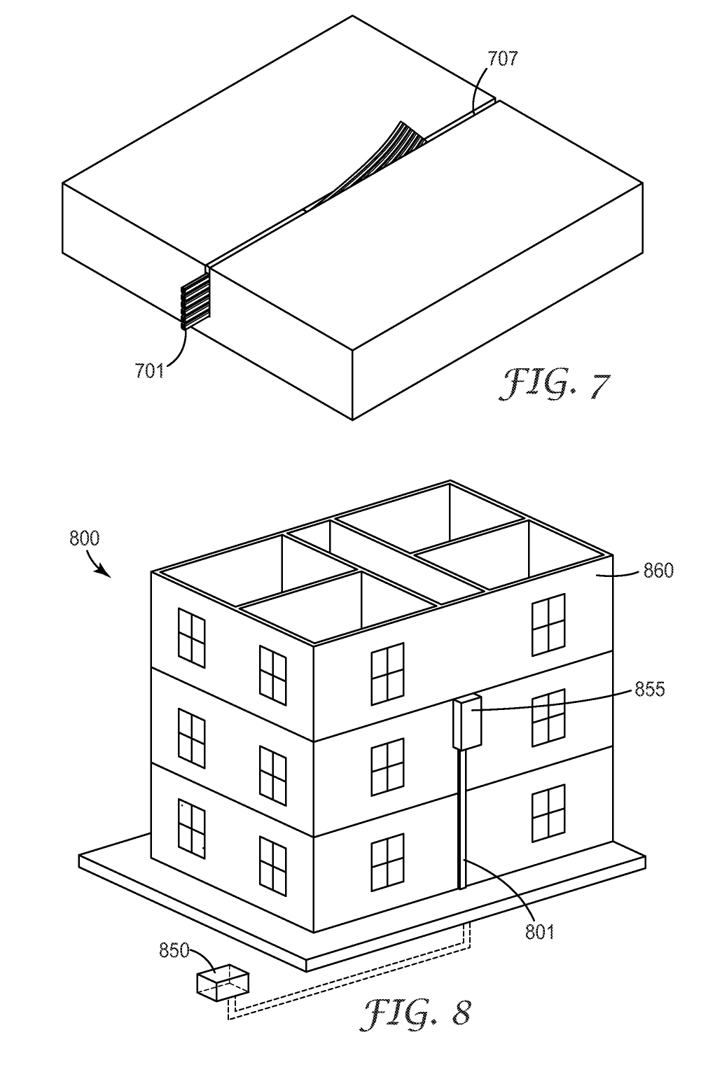

As also illustrated in FIG. 6, the cable assembly 601 may be positioned on the exterior surface of the building or premise 630. Alternatively, the cable assembly may be positioned within a premises access duct, such as a ventilation duct. FIG. 7 illustrates another potential position of the cable assembly. In this embodiment, a microtrench 707 may be cut into an appropriate portion of the premises (whether exterior or interior). The microtrench could also be cut in the side walk and used to cross streets such that larger trench does not need to be dug and backfilled in order to facilitate subgrade routing of the exemplary the exemplary cable assembly. Residual space in the microtrench can be filled with a conventional crack sealant material. The cable assembly 701 may be positioned within the microtrench 707 to reduce visibility of the assembly or provide protection for the cable assembly. The subassemblies described with respect to this and further system embodiments may be understood as synonymous with the smaller cable groupings described in the cable assembly embodiments above, and description of one or the other should be understood to describe its counterpart.

The cable assemblies illustrated thus far provide assemblies wherein the subassemblies or cable groupings (e.g. 208a, 208b, shown in FIGS. 2A-2C), that are split from the unitary cable assembly at the furcation points (e.g. 214a, 214b), include the cable assembly jacket or primary jacket 204 surrounding the subassembly or cable grouping, and the split occurs at the respective indentation 206. In other words, a cable grouping split from the cable assembly will still have the primary jacket surrounding it as it branches towards a second location.

Cable assembly 1400 in FIG. 14 illustrates a different contemplated aspect of the presently described invention. In this aspect of the invention, the subassembly or cable grouping 1408 may be split from the unitary cable jacket 1404 at the furcation point 1414, such that the portion of the unitary cable assembly 1400 surrounding the subassembly remains attached to the cabling system or cable assembly (even after the furcation point). This may be accomplished by including within the primary jacket 1404 a pull string 1421. Pull string 1421, which is positioned parallel to the cable unit 1408, may be pulled upward along the length of the unit until it reaches a desired furcation point 1414. Once the pull string has created a slit in the primary jacket 1404, the cable unit 1408 can be released from the primary jacket and furcated from the cable assembly with secondary jacket 1405 remaining around the electrical conductors and/or optical fibers (such as those shown in FIG. 14). This may be a desirable solution in a case where a user desires the furcated subassembly or cable grouping to be less visible to observers, and potentially where weatherproofing of the furcated subassembly or cable grouping is of lesser importance.

FIG. 8 illustrates another cabling system 800. This cabling system is intended for a wireless communication installation. In at least some embodiments, the wireless communication installation can include small cell radio system. Cabling system 800 includes a head end 850 and at least one remote radio unit 855 disposed on a support structure 860. Head end may be, for example, a base station, a back haul network, an aggregation point or a distributed antenna system head end unit. Head end 850 generates communication signal and also power to the cabling system. Cable assembly 801 connects the head end 850 to the at least one remote radio unit 855. The cable assembly may be understood as the cable assembly described in the embodiments presented earlier in the present description, including a plurality of cable units with a jacket surrounding the cable units and indentations in the jacket between adjacent cable units. At least one cable unit of the plurality of cable units is configured to carry a communications signal between the head end 850 and at least one radio unit 855. At least cable unit of the plurality of cable units is configured to transmit power for the at least one remote radio unit 855. In the illustrated embodiment, the support structure is the wall of a building. Though not specifically shown, the support structure may also be the roof of the building.

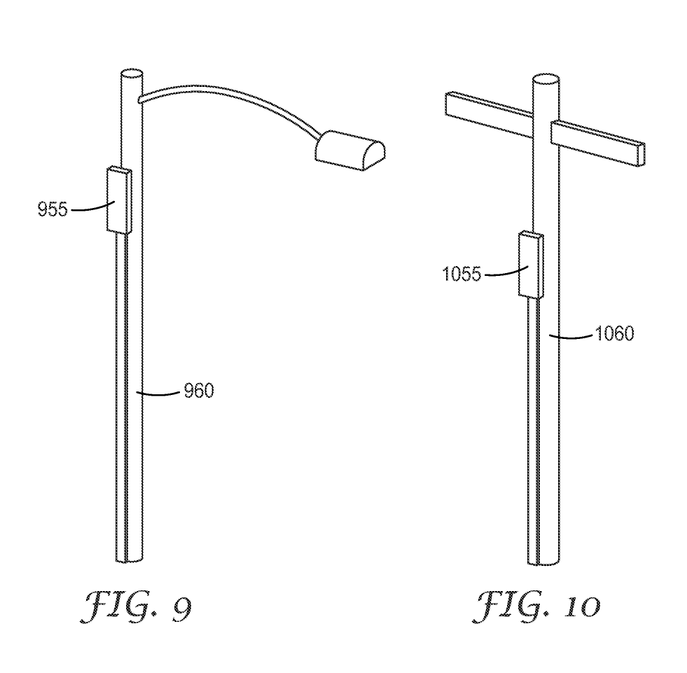

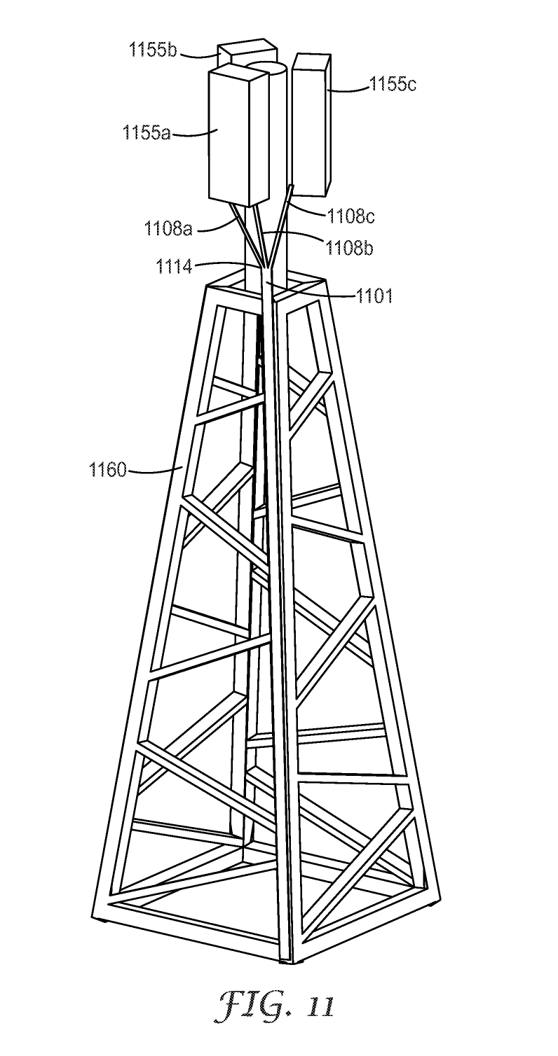

Any other number of support structures are also contemplated. For example, FIG. 9 illustrates a cabling system in which the remote radio unit 955 is disposed on a light pole 960. FIG. 10 illustrates a cabling system in which the remote radio unit 1055 is disposed on a telephone pole 1060. Other support structures, though not illustrated, such as the back of a road sign or housing of a stop light are also contemplated. FIG. 11 illustrates a cabling system in which the remote radio units 1155a, 1155b, and 1155c are disposed on a roof mounted support structure. This embodiment further illustrates that the cabling system 1101 is capable of being furcated at a point 1114 along the length of the cable assembly, such that at least one cable unit (1108a, 1108b or 1108c) is split from the plurality of cable units. This allows for the cable assembly to provide both communication signal and power to multiple radio units through the unitary cable assembly and cabling system. As with the cabling system described in FIGS. 6 and 7, where appropriate, the cable assembly may be positioned within a saw-cut microtrench. As with the premises cabling system, the cabling system for wireless communication installation may also be furcated such that the furcated portion is split either with the primary jacket still surrounding it, or without, as described in FIG. 14.

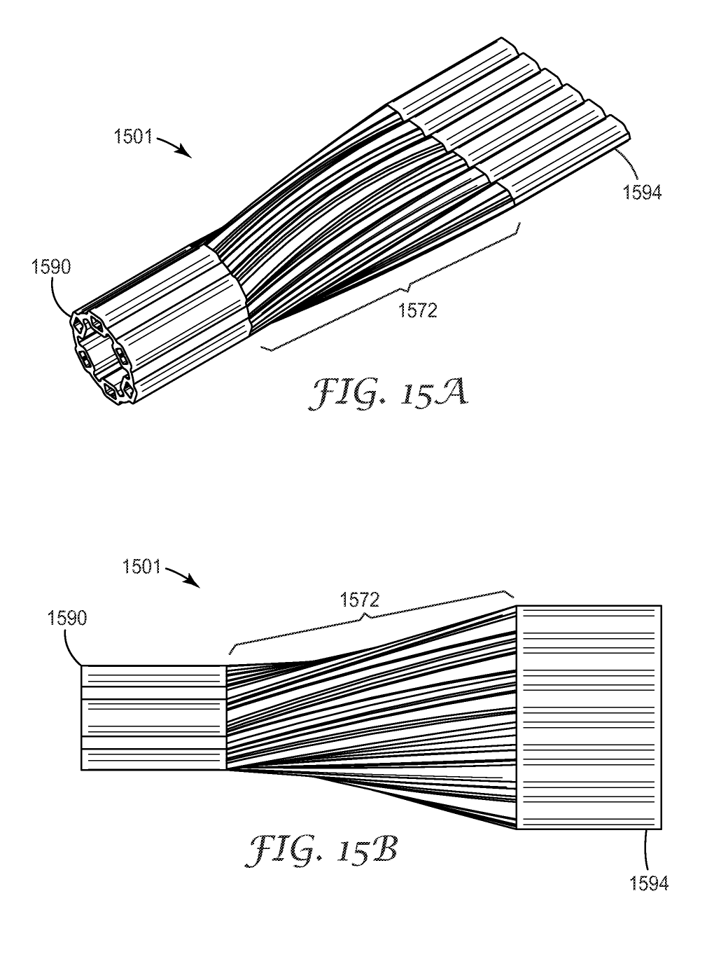

In some embodiments, it may also be desirable for the cable assembly to be configured in a different geometric configuration depending upon its location and delivery surroundings. For example, in some embodiments it may be desirable for the cable assembly to be wrapped into a cylindrical shape, such that it may more easily travel through an underground via or potentially a pipe line. However, when approaching an access point where furcation will occur, it may be desirable for the cable assembly to flatten out and potentially be spread across an exterior wall, for example, as shown in FIG. 6. FIGS. 15A-15B illustrate two views of one potential construction of such a cable assembly. As is apparent from the illustration, at a distal end 1590 disposed away from the furcation point or points, the cable assembly is curved in on itself such that it forms a cylindrical shape. The cable assembly then has a transition length 1572 in which the shape of the cable flattens from the cylindrical shape into a flat, rectangular-like construction. Finally, at a proximate end 1594 to the furcation location or locations, the cable assembly 1501 is flat, and may be closely mounted to a wall or the like without much protrusion from the surface.

The present invention should not be considered limited to the particular examples and embodiments described above, as such embodiments are described in detail in order to facilitate explanation of various aspects of the invention. Rather, the present invention should be understood to cover all aspects of the invention, including various modifications, equivalent processes, and alternative devices falling within the scope of the invention as defined by the appended claims.

We claim:

1. A cable assembly, comprising:
a plurality of cable units disposed within a primary jacket that surrounds the cable units, each cable unit comprising a secondary jacket surrounding its respective cable unit and positioned within the primary jacket, the primary jacket having a plurality of indentations disposed between adjacent cable units that allow an installer to furcate the cable assembly into smaller cable groupings, wherein the primary jacket is capable of remaining around each smaller cable grouping when the cable assembly is furcated, wherein at least one first cable unit of the plurality of cable units comprises optical fibers and at least one second cable unit of the plurality of cable units comprises an electrical conductor having a conductivity of greater than 1×10⁷ S/m.

2. The cable assembly of claim 1, wherein the smaller cable groupings are furcated from the cable assembly for a first length of the cable groupings at at least one point along the length of the cable assembly.

3. The cable assembly of claim 2, wherein the smaller cable groupings are furcated from the cable assembly at different points along the length of the cable assembly.

4. The cable assembly of cable 1, wherein the primary jacket surrounding a respective cable unit is capable of being opened by a pull string that is positioned parallel to the cable unit.

5. The cable assembly of claim 1, wherein the first cable unit comprises duplex optical fibers.

6. The cable assembly of claim 1, wherein the first cable unit comprises strength members.

7. The cable assembly of claim 1, wherein the first cable unit is configured such that two strength members are positioned on opposite sides of an optical fiber.

8. The cable assembly of claim 1, wherein the second cable unit comprises a pair of copper wires.

9. The cable assembly of claim 1, wherein the primary jacket is formed from a UV stabilized polyethylene material.

10. The cable assembly of claim 1, comprising at least six cable units.

11. The cable assembly of claim 1, comprising a plurality of first cable units comprising optical fibers.

12. The cable assembly of claim 1, comprising a plurality of second cable units comprising an electrical conductor.

13. A premises cabling system, comprising:
a cable assembly having a plurality of cable units disposed within a unitary cable assembly jacket that surrounds the cable units, the cable assembly jacket having a plurality of indentations disposed between adjacent cable units, wherein at least one cable unit of the plurality of cable units is configured to carry a communications signal, and at least one cable unit of the plurality of cable units is configured to transmit power; and
a furcation point positioned near an access location of a premises structure, wherein at least one subassembly is separated from the cable assembly and is routed to an access node within the premises structure.

14. The premises cabling system of claim 13, wherein the system comprises a plurality of furcation points positioned at different points along the length of the cable assembly.

15. The premises cabling system of claim 13, wherein the subassembly is split from the unitary cable assembly jacket at the furcation point, and the portion of the unitary cable assembly jacket surrounding the subassembly remains attached to the cabling system.

16. The premises cabling system of claim 13, wherein the subassembly that is split at the furcation point includes the cable assembly jacket portion surrounding the subassembly and the split occurs at the respective indentation.

17. The premises cabling system of claim 13, wherein the at least one cable that is configured to carry a communications signal is also configured to transmit power.

18. The premises cabling system of claim 13, wherein the cable assembly is capable of being positioned within a saw-cut microtrench.

19. A cabling system for a wireless communication installation, comprising:
a head end;
at least one remote radio unit disposed on a support structure; and
a cable assembly connecting the head end to the at least one remote radio unit, wherein the cable assembly has a plurality of cable units disposed within a unitary cable assembly jacket that surrounds the cable units, the cable assembly jacket having a plurality of indentations disposed between adjacent cable units, wherein at least one cable unit of the plurality of cable units is configured to carry a communications signal between the head end and the at least one remote radio unit, and at least one cable unit of the plurality of cable units is configured to transmit power for the at least one remote radio unit.

20. The cabling system of claim 19, wherein the cable assembly is capable of being furcated at a point along the length of the cable assembly, such that at least one cable unit is split from the plurality of cable units.

21. The cabling system of claim 19, wherein the cable unit is split from the unitary cable assembly jacket at the furcation point, and the portion of the unitary cable assembly jacket surrounding the cable unit remains attached to the cabling system.

22. The cabling system of claim 19, wherein the cable unit split at the furcation point includes the cable assembly jacket portion surrounding the cable unit.

23. The cabling system of claim 19, wherein the head end comprises a base station, a back haul network, an aggregation point or a distributed antenna system head end unit.

24. A cable assembly, comprising:
a plurality of cable units disposed within a unitary cable assembly jacket that surrounds the cable units, the cable assembly jacket having a plurality of indentations disposed between adjacent cable units, wherein at least one cable unit of the plurality of cable units is configured to carry a communications signal, and at least one cable unit of the plurality of cable units is configured to transmit electrical power; and
a furcation point positioned at a branch location on the cable assembly.
